(19) United States
(12) Patent Application Publication
(10) Pub. No.: US 2012/0001082 A1
(43) Pub. Date: Jan. 5, 2012

(54) RADIOGRAPHIC IMAGING SYSTEM

(75) Inventors: Makoto Shoho, Osaka (JP); Kazuo Hashiguchi, Osaka (JP)

(73) Assignee: Sharp Kabushiki Kaisha, Osaka (JP)

(21) Appl. No.: 12/998,159

(22) PCT Filed: Sep. 28, 2009
(86) PCT No.: PCT/JP2009/066820

§ 371 Date: Sep. 19, 2011

(30) Foreign Application Priority Data
Sep. 30, 2008 (JP) 2008-255484

(51) Int. Cl. G01T 1/20

(52) U.S. Cl. 250/369

(57) ABSTRACT

A response with a wider dynamic range is obtained without a need for irradiating strong radiation onto a subject (human body). A CCD controller 22 allows reading of imaging signals from CCD image sensors 1 to 12, which is performed twice during different time periods, once during a long exposure time period and once during a short exposure time period, with respect to the irradiation of a constant dose of radiation by an X-ray generator 25; and a main controller 26 allows a memory 24 to synthesize image data from the successively twice-read imaging signals into an image with proper timing. As a result, it becomes unnecessary to irradiate strong radiation onto a subject, such as a human body and other substances, as is done conventionally, owing to a radiation dose weak enough not to cause a harmful influence.

### TECHNICAL FIELD

The present invention relates to a radiographic imaging system, such as an X-ray imaging system, used, for example, for X-ray mammography and photographing of the chest and the appendicular skeleton.

### BACKGROUND ART

For conventional X-ray imaging systems used for X-ray imaging for medical diagnosis, an imaging system has been generally used in which a photograph film is closely adhered to a fluorescent sensitizing paper, an X-ray image is exposed, and the X-ray image is developed, fixed, washed and dried by an automatic developing device. In recent years, however, computed radiography (CR), which uses an imaging plate (IP) instead of a film, has been replacing the conventional imaging system in view of having simple handling, such as requiring no development processing, and easy filing owing to digitized data.

In an X-ray imaging apparatus with an imaging plate (IP) method, however, it is necessary to scan and load an image using a scanner or the like in order to obtain a digital image after X-ray photographing. This is problematic in terms of simplicity because it requires a few minutes to obtain the image and an eraser used only for data erasing.

Accordingly, there is a recent transition to digital radiography (DR), which is about to take place. In digital radiography, an X-ray image is input into an image input apparatus either directly or indirectly to obtain graphic signals.

One of the examples of digital radiography includes a system in which an image obtained by using X- rays is converted into a visible light image with a scintillator and observation is conducted with a flat panel detector (FPD) with a thin film transistor (TFT). This system has characteristics of using a smaller apparatus and having better picture quality than computed radiography (CR). This system, however, has some disadvantages, such as an increase in the cost due to the use of a large scale TFT panel, and a lowering in the resolution down to 3 lp/mm to 4 lp/mm due to the large pixel size of the TFT.

In addition, another example of digital radiography (DR) includes a publicly known method for using a scintillator and a plurality of CCDs in combination, as shown in Reference 1. This method for using a scintillator and a plurality of CCDs in combination has advantages in terms of cost by using inexpensive CCDs and the ability to set any resolution by selecting the magnification in an optical system. However, there exists a problem in the dynamic range, a major performance factor of a DR system in digital radiography (DR).

An effective image-area ratio will be described with reference to FIG. 6 with regard to a case where four area sensors are used for a radiographic imaging detector in a conventional radiographic imaging apparatus with a scintillator and a plurality of CCDs used in combination.

FIG. 6 is a schematic view describing an effective image-area ratio of area sensors constituting a radiographic imaging detector in the conventional radiographic imaging apparatus disclosed in Reference 1.

As illustrated in FIG. 6, a conventional radiographic imaging detector 200 includes an X-ray scintillator 202 for emitting light in accordance with the dose of transmitted X-rays on an area sensor 201 for obtaining imaging signals. An imaging area is divided into a plurality of areas when the imaging area is large. Herein, when the radiographic imaging detector 200 uses four area sensors 201, the X-ray scintillator 202 is divided into four likewise. The four individually divided areas on the X-ray scintillator 202 are each referred to as a divided image area 202a. The image of the individual divided image area 202a is condensed through a lens 203, and the image is formed on a corresponding area sensor 201. A plurality of lenses 203 are arrange to constitute a lens array 203a.

This area, on which one divided image area 202a is imaged on the corresponding area sensor 201, is referred to as an effective image area 201a. In addition, an area with sensitivity in the area sensor 201 is referred to as a sensible image area 201b.

Herein, the effective image area 201a is imaged smaller than the sensible image area 201b to have room in the periphery (to provide pixels in the periphery which are not used). The ratio of the effective image area 201a to the sensible image area 201b (effective image area 201a/sensible image area 201b) is referred to as an effective image-area ratio. In addition, image data of the overall area created from the four divided image areas 202a (i.e., the overall X-ray scintillator 202) is referred to as overall image data.

In general, a fluorescent (scintillator) used in a DR system for digital radiography (DR) exhibits a response (emission) with essentially good linearity in accordance with the wide change in the X-ray dose of 10⁶, ranging from an extremely weak X-ray dose (10⁻³ mR), which penetrates a human body during high-sensitivity photographing, to a large X-ray dose (10³ mR) during low-sensitivity photographing.

Thus, the responding manner by the subsequent photoelectric conversion process is the key to obtaining this wide dynamic range.

Since the aforementioned flat panel detector (FPD) with a thin film transistor (TFT) has a large pixel size, it has a relatively wide dynamic range. On the other hand, the dynamic range of a photodiode (PD) of CCDs is 10³ or less, which is not sufficient enough to cover the light emission characteristic of a fluorescent (scintillator). Furthermore, since the conventional radiographic imaging apparatus disclosed in Reference 1 uses a normal CCD driving method, an image with a wide dynamic range cannot be obtained.

As to means for solving the problem, as disclosed in Reference 2, a fluoroscopic apparatus is proposed in which a plurality of imaging signals obtained by imaging a subject by changing the intensity and dose of radiation onto the subject are synthesized to form one image.

In Reference 2, a plurality of X-ray energy levels (where the intensity or the irradiation dose of the X-ray is changed) are irradiated onto a subject, and an image with a wide dynamic range and clearer light and shade can be obtained without an invisible portion with saturation or a flattened shadow portion.

Reference 1: Japanese Laid-Open Publication No. 2000-235709

Reference 2: Japanese Laid-Open Publication No. 03-38979

### DISCLOSURE OF THE INVENTION

Although it is possible for the conventional fluoroscopic apparatus disclosed in Reference 2 to obtain an image with a wide dynamic range and clearer light and shade, it is necessary to change the radiation dose irradiated onto a subject between a strong radiation dose and a weak radiation dose. Thus, the conventional fluoroscopic apparatus has the disadvantage that strong radiation needs to be irradiated onto a subject (human body). For example, with regard to an X-ray medical diagnosis apparatus, it is not preferable to irradiate strong radiation onto a human body in view of a harmful influence upon the human body. Even in a case of observing a substance, there is a possibility of changing the state of the sample itself by the irradiation of strong radiation. In linear areas surrounded by line sensors as in Reference 2, it is not possible to cope with a case where a wide dynamic range is needed with a process with either a strong radiation dose or a weak radiation dose.

The present invention is intended to solve the conventional problems described above. The objective of the present invention is to provide a radiographic imaging system capable of obtaining a response with a wider dynamic range without a need for irradiating strong radiation onto a subject (human body).

A radiographic imaging system according to the present invention includes: a radiation generating section for generating and irradiating radiation onto a subject; a scintillator section for converting the radiation from the subject into light; an imaging section for performing a photoelectric conversion on the light from the scintillator section and imaging the light as an image of the subject; and a controlling section for reading imaging signals from the imaging section multiple times with a different length of an exposure time period with respect to the irradiation of a constant dose of radiation by the radiation generating section, and controlling to synthesize image data from the imaging signals read out multiple times into an image, thereby achieving the objective described above.

Preferably, in a radiographic imaging system according to the present invention, in the imaging section, at least two exposures of at least one of a long time exposure and at least one of a short time exposure are performed under the control of the controlling section, and readings by the imaging section are performed at least twice corresponding to at least once with the long time exposure and at least once with the short time exposure.

Still preferably, in a radiographic imaging system according to the present invention, the long time exposure is from 50 msec to 500 msec, and the short time exposure is from 10 msec to 50 msec.

Still preferably, a radiographic imaging system according to the present invention further includes an A/D conversion section for performing A/D conversion on the imaging signals read from the imaging section, and a storage section for temporarily storing graphic signals from the A/D conversion section.

Still preferably, in a radiographic imaging system according to the present invention, the storage section synthesizes at least the graphic signals from the long time exposure and the graphic signals from the short time exposure of the imaging section.

Still preferably, in a radiographic imaging system according to the present invention, the radiation generating section irradiates radiation with a radiation dose weak enough not to cause a harmful influence to the subject.

Still preferably, in a radiographic imaging system according to the present invention, the radiation dose ranges 170 μGy (microgray) ±20 μGy (microgray).

Still preferably, in a radiographic imaging system according to the present invention, the imaging section includes: a plurality of photodiodes arranged in two dimensions for performing a photoelectric conversion; an electric charge transferring section for reading and transferring signal charges in a predetermined direction, which are photoelectrically converted by the photodiode; and an output section for converting the signal charges transferred by the electric charge transferring section into voltages, and amplifying the converted voltages to allow imaging signals to be output.

Still preferably, in a radiographic imaging system according to the present invention, the imaging section are divided into a plurality of divided areas, each of the plurality of divided areas including: a plurality of photodiodes arranged in two dimensions for performing a photoelectric conversion; an electric charge transferring section for reading and transferring signal charges in a predetermined direction, which are photoelectrically converted by the photodiode; and an output section for converting the signal charges transferred by the electric charge transferring section into voltages, and amplifying the converted voltages to allow imaging signals to be output.

Still preferably, in a radiographic imaging system according to the present invention, the controlling section controls at least signal output of the imaging signals from the long time exposure and the imaging signals from the short time exposure of the imaging section.

Still preferably, in a radiographic imaging system according to the present invention, during a state of irradiating radiation by the radiation generating section, an electric potential of the imaging section is reset with the timing of an electronic shutter, by the timing at which an overflow drain signal rises; and a period prior to the timing at which the overflow drain signal rises is defined as one of a long exposure time period or a short exposure time period, while a period after the timing at which the overflow drain signal rises is defined as the other one of the long exposure time period or the short exposure time period.

Still preferably, in a radiographic imaging system according to the present invent ion, an overflow drain voltage is either the same or changed during the long exposure time period and the short exposure time period.

Still preferably, in a radiographic imaging system according to the present invention, the imaging section is constituted of a solid-state imaging array, which is two dimensionally arranged facing the scintillator section.

Still preferably, in a radiographic imaging system according to the present invention, the scintillator section includes an image intensifier provided therein as an amplifier.

Still preferably, in a radiographic imaging system according to the present invention, the radiation is any of X-rays, an electron beam, ultraviolet rays and infrared rays.

Still preferably, in a radiographic imaging system according to the present invention, the radiographic imaging system uses at least one of a frame accumulation driving in which signal reading from the photodiode is performed by dividing lines into odd-number lines and even-number lines, or a field accumulation driving in which signal reading from the photodiode is performed by adding data from odd-number lines and even-number lines.

Still preferably, in a radiographic imaging system according to the present invention, during the multiple readings, an exposure containing useful information is performed by the frame accumulation driving and the other exposures are performed by the field accumulation driving.

The functions of the present invention with the structures described above will be described hereinafter.

In the present invention, the reading of imaging signals from an imaging section is performed multiple times with a different length of an exposure time period with respect to the irradiation of a constant dose of radiation by a radiation generating section, and image data, which is obtained from imaging signals read out multiple times, is synthesized for an image.

As a result, it becomes unnecessary to irradiate strong radiation onto a subject, such as a human body and other substances, and a response with a wider dynamic range can be obtained.

According to the present invention with the structures described above, the reading of imaging signals from the imaging section is performed multiple times at different exposure time periods with respect to the irradiation of a constant dose of radiation by a radiation generating section, and image data, which is obtained from imaging signals read out multiple times, is synthesized for an image. Therefore, a response with a wider dynamic range can be obtained with a radiation dose weak enough not to cause a harmful influence to a subject, such as a human body and other substances, without a need for irradiating strong radiation onto such a subject, such as a human body and other substances, as is done conventionally.

### BRIEF DESCRIPTION OF THE DRAWINGS

FIG. 1 is a block diagram illustrating an exemplary structure of essential parts of an X-ray imaging system in an embodiment of the present invention.

FIG. 2 is a schematic view describing an exemplary planar structure of the CCD image sensor 1 in FIG. 1.

FIG. 3(a) is an enlarged view of a planar portion P, including photodiodes PD, in FIG. 2. FIG. 3(b) is a cross sectional view of the line A-B in FIG. 3(a).

FIG. 4 is a timing diagram of respective signals for describing a wide dynamic range mode of a frame accumulating method by two-time emissions of an X-ray source in the radiographic imaging system 20 in FIG. 1.

FIG. 5 is a timing diagram of respective signals for describing a case where an electronic shutter is used in a wide dynamic range mode of a frame accumulation method by a one-time emission of an X-ray source in the radiographic imaging system 20 in FIG. 1.

FIG. 6 is a schematic view describing an effective image-area ratio of area sensors constituting a radiographic imaging detector in the conventional radiographic imaging apparatus disclosed in Reference 1.

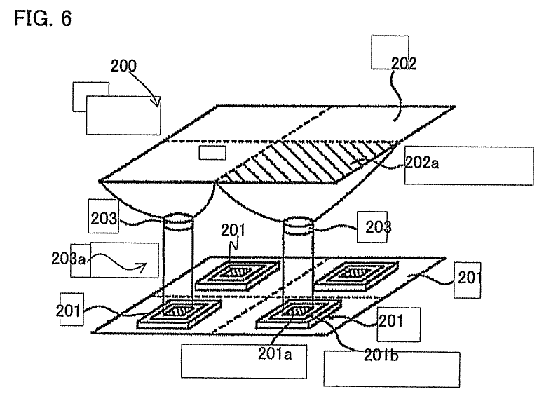

20 X-ray imaging apparatus
1-12 CCD image sensor
21 scintillator
22 CCD controller
23 A/D converter
24 memory
25 X-ray generator
26 main controller
27 arithmetic unit
28 personal computer
φᵥ₁-φᵥ₄ vertical transfer clock
T electric charge transfer pulse
VCCD vertical electric charge transferring section
PD photodiode
101 photodiodes on an odd-number line
101a photodiodes on an even-number line
T1 PD long exposure time period of odd-number line
T2 PD long exposure time period of even-number line
T11 PD short exposure time period of odd-number line
T12 PD short exposure time period of even-number line
T21 PD short exposure time period of odd-number line at a black level
T22 PD short exposure time period of even-number line at a black level
L irradiation period of low intensity X-rays
L1 long irradiation period of low intensity X rays
L2 short irradiation period of low intensity X-rays
OS output signal
OUT1, OUT11, OUT21 odd-number line side signal output
OUT2, OUT12, OUT22 even-number line side signal output

### BEST MODE FOR CARRYING OUT THE INVENTION

Hereinafter, an embodiment of a radiographic imaging system according to the present invention, where it is applied to an X-ray imaging system, will be described in detail with reference to the attached figures.

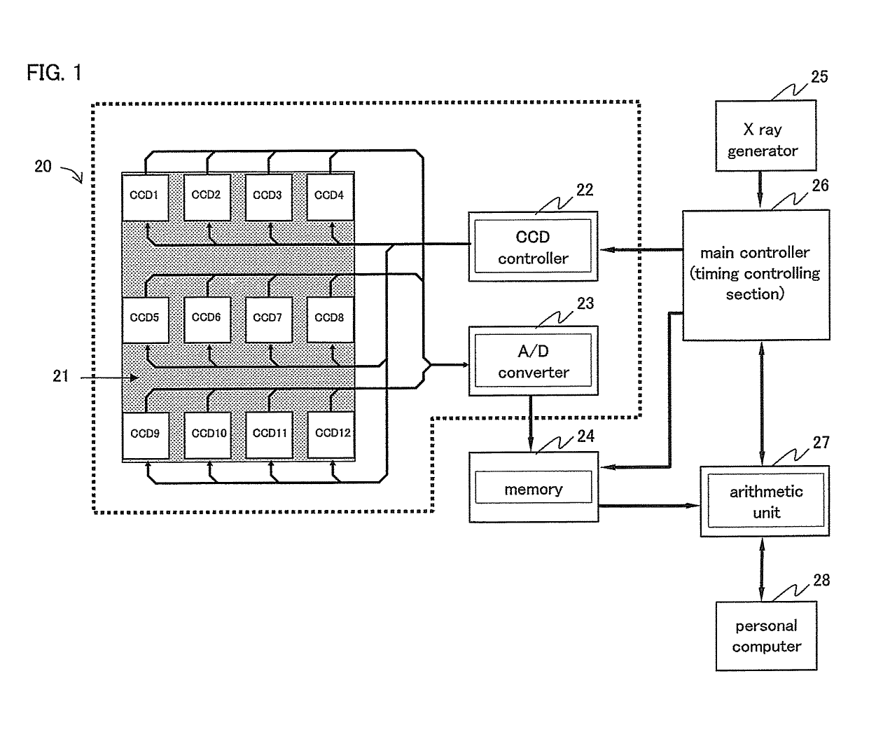

FIG. 1 is a block diagram illustrating an exemplary essential part structure of an X-ray imaging system in an embodiment of the present invention.

In FIG. 1, an X-ray imaging apparatus 20 according to the present embodiment includes: CCD image sensors 1 to 12 as an imaging section for performing a photoelectric conversion on a visible light, such as fluorescence, from a scintillator 21 to be described later, to be imaged as an image of a subject; a scintillator 21 as a scintillator section for converting radiation from a subject into a light (fluorescence, herein); a CCD controller 22 for controlling the reading of imaging signals from the CCD image sensors 1 to 12; an A/D converter 23 as an A/D conversion section; a memory 24 as a storage section for image synthesization processing; an X-ray generator 25 as a radiation generating section for generating and irradiating radiation (X-rays, an electron beam, ultraviolet rays and infrared rays; herein, it is X-rays) onto a subject; a main controller 26 for controlling operation timing of the CCD controller 22 and memory 24; an arithmetic unit 27 for performing a predetermined image processing; and a personal computer 28 for screen display, wherein the twelve CCD image sensors 1 to 12 are divided as one block, and the CCD controller 22 for CCD driving and the A/D converter 23 are provided for each of the twelve CCD image sensors 1 to 12.

The CCD controller 22 and main controller 26 constitute a controlling section, and the controlling section reads imaging signals from the CCD image sensors 1 to 12 multiple times with different lengths of exposure time periods with respect to the irradiation of a constant dose of radiation by the radiation generating section, and image data, which is obtained from imaging signals read out multiple times, is synthesized into an image with the memory 24.

Each of the CCD image sensors 1 to 12 is a CCD solid-state imaging element, and is constituted of a plurality of photodiodes functioning as a plurality of light receiving sections for performing a photoelectric conversion on imaging light from the fluorescence of the scintillator 21 to capture an image from the imaging light. In this case, the imaging section is divided into a plurality of divided areas each of which is constituted of the CCD image sensors 1 to 12, and each of the CCD image sensors 1 to 12 includes: a plurality of photodiodes PD arranged in two dimensions for performing a photoelectric conversion; an electric charge transferring section for reading and transferring signal charges in a predetermined direction, which are photoelectrically converted by the photodiode PD; and an output section for converting the signal charges transferred by the electric charge transferring section into voltage, and amplifying the converted voltage to allow imaging signals to be output. The range of the X-ray dose photographed by the CCD image sensors 1 to 12 functioning as a CCD solid-state imaging element is from 0 μGy to 50 μGy, and the exposure time period is from 50 msec to 500 msec for a long time exposure, and an exposure time is one-tenth or less of the long time exposure for a short time exposure.

The scintillator 21 is a light receiving sensor for radiation such as X-rays, which is made of a substance that emits fluorescence when irradiated with ionizing radiation. The scintillator 21 is positioned facing the CCD image sensors 1 to 12 each constituted of a two-dimensionally arranged solid-state imaging array. An image intensifier (amplifier) may be added to the scintillator 21.

The CCD controller 22 performs signal reading controlling to successively control the output of signal charge reading pulses to the CCD image sensors 1 to 12 and to allow data (a plurality of imaging signals) from the CCD image sensors 1 to 12 to be output to the A/D converter 23.

The A/D converter 23 performs A/D conversion into image data on the imaging signals, which are successively read out from the CCD image sensors 1 to 12.

The memory 24 temporarily stores the image data (a plurality of imaging signals) on which A/D conversion was performed by the A/D converter 23. The memory 24 is used to synthesize imaging signals from a long time exposure and imaging signals from a short time exposure into an image. The imaging signals from a long time exposure, which arrive first, are stored in the memory 24 (frame memory), and the imaging signals from a short time exposure, which arrive subsequently, and the imaging signals stored in the memory 24 (frame memory) are processed to be added with one another to be synthesized into an image, thus showing the difference of light and shade. As such, an image with clear light and shade is overlapped with a flattened image, so that a distinct image can be obtained.

The X-ray generator 25 generates X-rays as radiation and irradiates the X-rays onto a subject or an object to be measured.

Hereinafter, the irradiation energy of the X-rays in this case (units: mR or dose) will be described in detail.

X-ray doses vary depending on photographing sites or photographing distances. For chest photographing, it is conducted with “approximately 120 kV, 3 mAs to 5 mAs, SID (distance between a tubular lamp focal point to an object to be photographed): 180 cm, with grids”. This is a weak X-ray dose which will not cause a harmful influence to a human body or to the state of a sample itself since it is not preferable to irradiate a strong radiation dose onto a human body, and even for an observation of a substance, it is not preferable to allow the state of the sample itself to be changed due to such strong irradiation of the radiation.

After transmitting through a patient or grids, the dose is significantly reduced and hits a fluorescent plate, and thus converted fluorescence is photographed by the CCD solid-state imaging elements. At this stage, for example, an indication of 120 kV and 5 mAs (tube current and photographing time) results in 120 kV 125 mA 40 msec (5 mAs=125 mA×0.04 sec) or the like. At this stage, the X-ray dose ranges 170 μGy (microgray) ±20 μGy (microgray). This means that an X-ray dose of about 170 μGy (microgray) is irradiated onto the patient. According to testing results, the maximum value of the dose after the transmission through the patient or grids is about 50 μGy (microgray) in the case of CCD solid-state imaging elements. Accordingly, the CCD solid-state imaging elements detects an X-ray dose ranging from 0 to 50 μGy (microgray) for imaging.

However, this X-ray dose depends on the performance of the, fluorescent plate. For a dark fluorescent plate, a larger dose is necessary, while photographing can be performed with a smaller dose for a bright fluorescent plate.

The solid-state imaging elements receive the X-rays in the form of fluorescence converted at the fluorescent plate. Since the dynamic range of the solid-state imaging elements is narrower than that of the fluorescent plate, the solid-state imaging elements, which have a narrow response range, read a plurality of times of fluorescent accumulation with different lengths of accumulation time periods so that the performance of the fluorescent plate can be utilized to its maximum.

As a result, it becomes possible to obtain an image even in a case when pixels are saturated with a dose exceeding the response range or when there is no pixel response with a dose below the response range in a system with the conventional solid-state imaging elements.

The main controller 26 is a timing controlling section for controlling the timing of outputting data from the CCD image sensors 1 to 12 to the A/D converter 23, and the timing of outputting data from the A/D converter 23 to the memory 24, by controlling the CCD controller 22. The main controller 26 controls the CCD controller 22 in such a controlling manner that signal accumulation with a different length of an accumulation time period and reading of the signal charges thereof are performed at least twice during one photographing opportunity at respective photodiodes PD in the CCD image sensors 1 to 12, and the read-out signal charges are synthesized by an external signal processing circuit (memory 24 herein).

The arithmetic unit 27 performs an arithmetic operation and image processing as appropriate on the image data from the memory 24 (frame memory) so that the image will be clear. If image synthesization is not performed by the memory 24, it is possible for the arithmetic unit 27 to perform the image synthesization processing as its arithmetic processing.

The personal computer 28 receives the input of the data accumulated in the memory 24 so that the X-ray image of the subject can be displayed on a display screen thereof.

As described above, reading of the signal charges to the electric charge transferring section is performed multiple times during one photographing opportunity by respective photodiodes PD in the CCD image sensors 1 to 12, the signal charges read out multiple times are read out to an external part without addition, and image synthesization is performed by image processing. As a result, even if a subject is imaged, with areas of high brightness and low brightness coexisting as light and shade, these are synthesized and a response can be obtained with a wider dynamic range, without causing a flattened image as is done conventionally.

Hereinafter, the CCD image sensor 1 will be further described in detail.

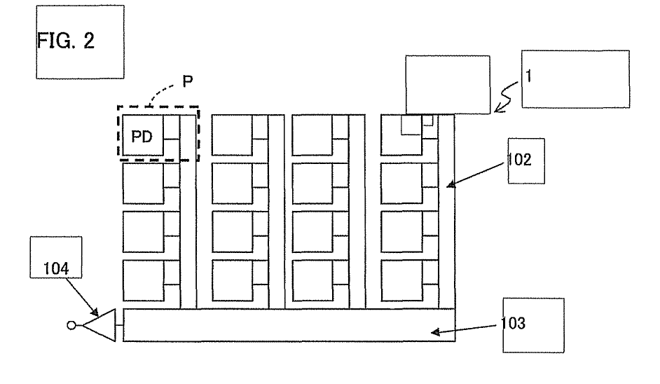

FIG. 2 is a schematic view describing an exemplary planar structure of a CCD image sensor 1 in FIG. 1.

As illustrated in FIG. 2, the CCD image sensor 1 according to the present embodiment includes a plurality of photodiodes PD arranged two dimensionally in row and column directions in a matrix. The CCD image sensor 1 reads signal charges from the plurality of photodiodes PD to a predetermined vertical electric charge transferring path 102 (VCCD), and transfers the signal charges in a vertical direction by the predetermined vertical electric charge transferring path 102.

Next, the signal charges from a plurality of the vertical electric charge transferring paths 102 are transferred to a horizontal electric charge transferring path 103, and the signal charges received from the respective vertical electric charge transferring paths 102 are transferred in a horizontal direction by the horizontal electric charge transferring path 103. A signal detecting section 104 is provided in an electric charge transfer end portion of the horizontal electric charge transferring path 103. The signal detecting section 104 successively receives the signal charges transferred from the horizontal electric charge transferring path 103, and amplifies voltages in accordance with the electric charge amount of the signal charges and outputs the voltages as imaging signals.

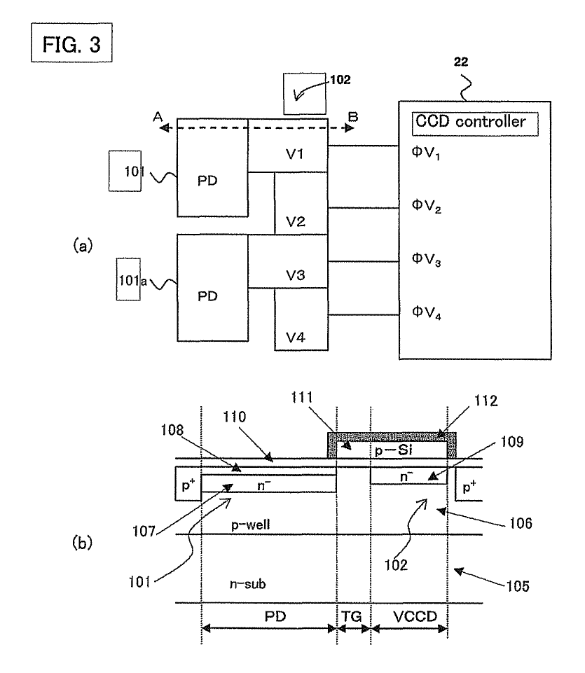

FIG. 3(a) is an enlarged view of a planar portion P, including photodiodes PD, in FIG. 2. FIG. 3(b) is a cross sectional view of the line A-B in FIG. 3(a).

As illustrated in FIG. 3(a), the electric charge transferring section according to the present embodiment reads signal charges generated at the photodiodes PD and transfers them in a vertical direction through the vertical electric charge transferring path (VCCD). For example, signal charges generated at photodiodes 101 on odd-number lines are transferred to an electric charge transferring area below a transfer electrode V₁. Signal charges generated at photodiodes 101a on even-number lines located below the photodiodes 101 on odd-number lines in a plan view, are transferred to an electric charge transferring area below a transfer electrode V₃ . For example, four transfer electrodes V₁ to V₄ constituting the vertical electric charge transferring path 102 (VCCD) are configured as one group, and four phases of vertical transfer clocks φᵥ₁ to φᵥ₄ are supplied from the CCD controller 22, functioning as an electric charge transfer driving section, to respective transfer electrodes V₁ to V₄ for electric charge transfer driving.

The transfer electrode V₁ also functions as a transfer gate TG for reading out the signal charges accumulated in the photodiode 101 to the vertical electric charge transferring path 102. Similarly, the transfer electrode V₃ also functions as a transfer gate TG for reading out the signal charges accumulated in the photodiode 101a to the vertical electric charge transferring path 102.

As illustrated in FIG. 3(b), the vertical electric charge transferring path 102 (VCCD) according to the present embodiment includes a P-type well 106 provided on a front surface side of an N-type silicon substrate 105. An N-type region 107 is provided on a front surface side of the P-type well 106, the N-type region 107 constituting the photodiode 101. Further, on the front surface side, a surface P+ type diffusion layer 108 is provided for reducing dark current.

A transfer gate electrode 111 is formed above an N-type diffusion layer 109 constituting the vertical electric charge transferring path 102, and above a P-type region of the P-type well 106 between the N-type diffusion layer 109 and the N-type region 107, with an insulation film 110 interposed therebetween. The application of a positive electric potential to the transfer gate electrode 111 (transfer electrode V₁) causes a channel to be formed in the P-type region of the P-type well 106 below the transfer gate electrode 111, resulting in reading out the signal charges accumulated in the photodiode 101 to the N-type diffusion layer 109 of the vertical electric charge transferring path 102.

A light shielding film 112 made of aluminum material or the like is provided above the transfer gate electrode 111 as well as the vertical transfer electrodes and the horizontal transfer electrodes.

A vertical overflow drain (VOD) structure is applied to the N-type silicon substrate 105. The vertical overflow drain (VOD) structure functions as an overflow drain section for sweeping out excess signal charges to the side closer to the N-type silicon substrate 105, which excess signal charges are generated when a voltage that can be reverse biased to the P-type well 106 is applied to the N-type silicon substrate 105, and excess light enters that is more than the potential well of the photodiode 101.

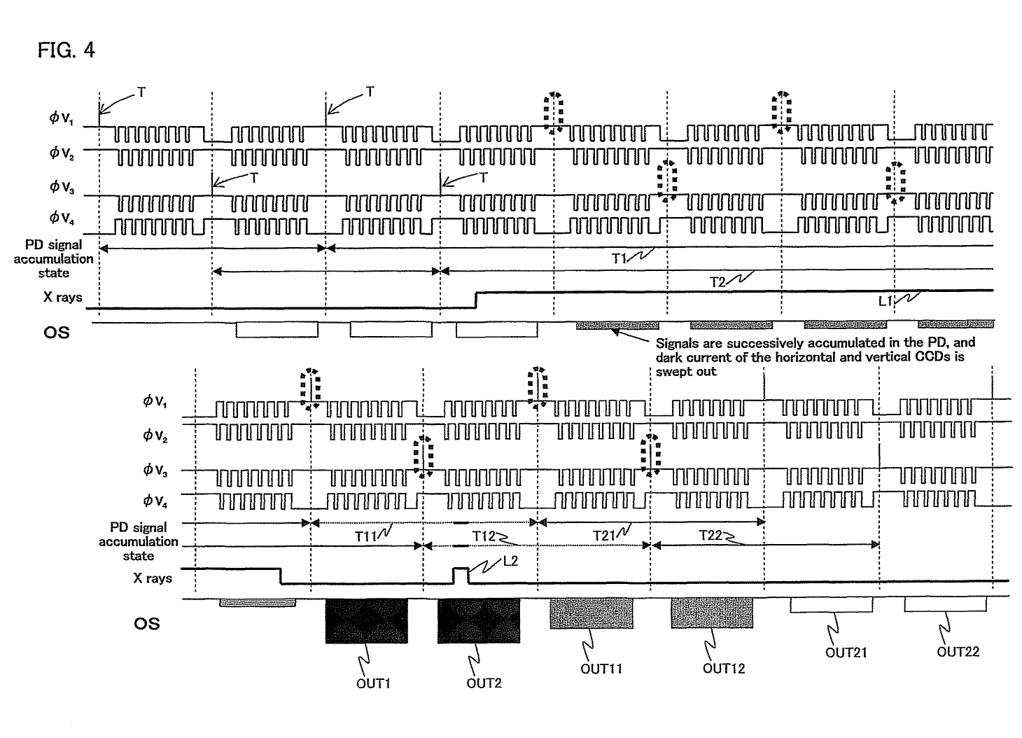

FIG. 4 is a timing diagram of respective signals for describing a wide dynamic range mode of a frame accumulating method by two-time emissions of an X-ray source in the radiographic imaging system 20 in FIG. 1.

In FIG. 4, among the vertical transfer clocks φᵥ₁ to φᵥ₄ representing vertical transfer controlling signals from the CCD controller 22, pulses rising on the low level side (pulses rising towards the lower side) are for controlling electric charge transferring by the VCCD, while respective electric charge transfer pulses T in a trigger shape rising on the high level side of the vertical transfer clocks φᵥ₁ and φᵥ₃ are for transferring electric charges from the photodiode PD to the VCCD. In summary, the PDs on the odd-number lines are connected to the transfer electrode V₁ for electric charge transferring, and the PDs on the even-number lines are connected to the transfer electrode V₃ for electric charge transferring. For the electric charge accumulation state of the photodiodes PD, the long period indicated by the upper set of arrows represents a PD long exposure time period T1 of the odd-number lines, and the long period indicated by the lower set of arrows represents a PD long exposure time period T2 of the even-number lines. Subsequently, positions where the electric charge transfer pulses T should rise are circled by a dotted line, but the electric charge transfer pulses T do not rise for two cycles (two times), thus being in a long time exposure state with no electric charge transferring from the photodiodes PD to the VCCD. The following short period indicated by the upper set of arrows represents a PD short exposure time period T11 of the odd-number lines, and the short period indicated by the lower set of arrows represents a PD short exposure time period T12 of the even-number lines. Further, a PD short exposure time period T21 of the odd-number lines indicated by the upper set of arrows and a PD short exposure time period T22 of the even-number lines indicated by the lower set of arrows represent a period at a black level in which X-rays are not irradiated from the X-ray source, the X-ray generator 25. X-rays are emitted twice, once during a long irradiation period L1 and once during a short irradiation period L2, with a low intensity (X-ray dose that does not cause a harmful influence to a living body) by the X-ray generator 25. OS stands for an output signal (output signals). Low intensity X-rays are emitted during the long irradiation period L1 and electric charges are subsequently transferred from the photodiodes PD, and imaging signals are output in the order of an odd-number line side signal output OUT1 and an even-number line side signal output OUT2. Further, low intensity X-rays are emitted during the short irradiation period L2 and electric charges are subsequently transferred from the photodiodes PD, and imaging signals are output in the order of an odd-number line side signal output OUT11 and an even-number line side signal output OUT12. An odd-number line side signal output OUT21 and an even-number line side signal output OUT22 thereafter are signal outputs at a black level.

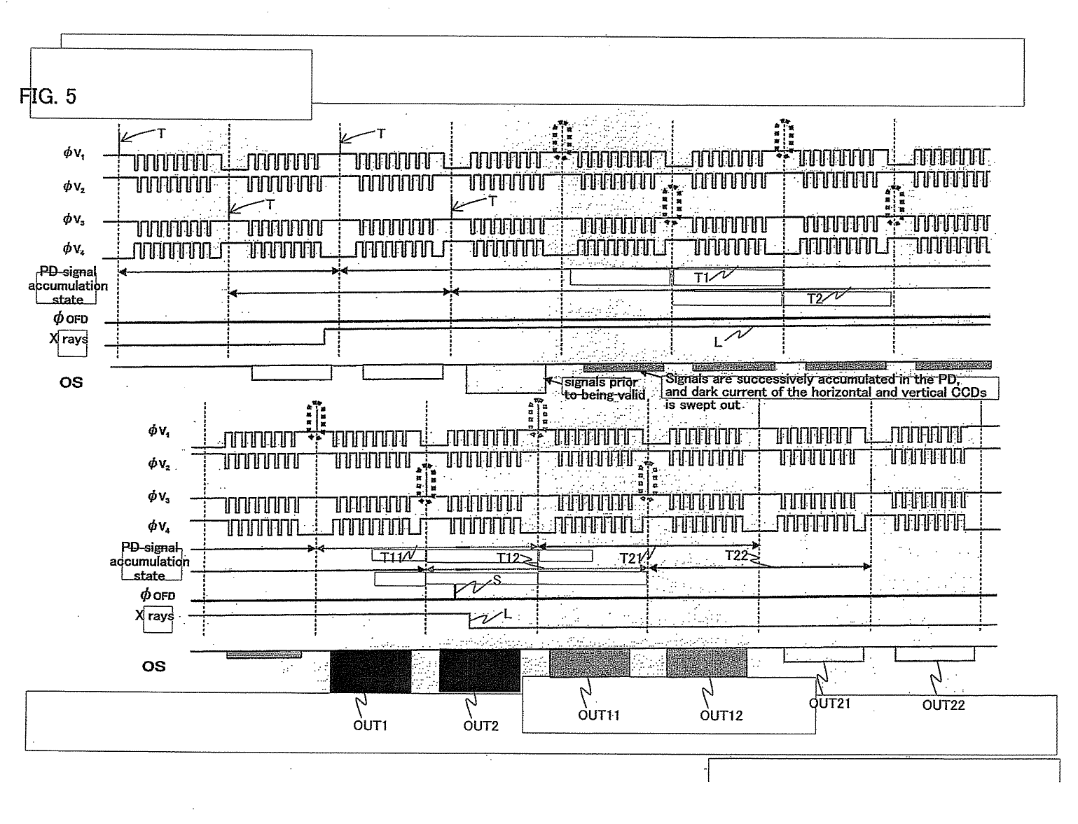

FIG. 5 is a timing diagram of respective signals for describing a case in which an electronic shutter is used in a wide dynamic range mode of a frame accumulation method by a one-time emission of an X-ray source in a radiographic imaging system 20 in FIG. 1.

The difference between the case of FIG. 4 and the case of FIG. 5 is that an electronic shutter is used in the case of FIG. 5. While X-rays are emitted twice, once during a long irradiation period L1 and once during a short irradiation period L2, with a low intensity (X-ray dose that does not cause a harmful influence to a living body) by the X-ray source, the X-ray generator 25 in FIG. 4, X-rays are emitted once during an irradiation period L (a long irradiation period L1+a short irradiation period L2) with a low intensity (X-ray dose that does not cause a harmful influence to a living body) by the X-ray source, the X-ray generator 25 in FIG. 5. In this case, the accumulation of signal charges in the photodiode PD owing to the fluorescence from the scintillator 21 by X-rays is reset by the output of a rising signal (timing signal S of an electronic shutter) in an overflow drain signal φOFD, and the exposure time can be divided into a PD long exposure time period T1 and a PD short exposure time period T11 as well as a PD long exposure time period T2 and a PD short exposure time period T12, with respect to the irradiation period L of X-rays.

In this case an electronic shutter is used. While the X-ray source is maintained at a high level, the electric potential of the CCD is reset at the rise of the rising signal (timing signal S of an electronic shutter) of the OFD (overflow drain). A long time signal continues up to this point, and a short time signal begins thereafter, thereby dividing the irradiation by the X-ray source into two types of time.

During the state of irradiating radiation by the X-ray generator 25, the timing of the electronic shutter is when the electric potential of the CCD image sensors 1 to 12, as an imaging section, is reset by the timing (timing signal S of an electronic shutter) at which the overflow drain signal φOFD rises. Further, the period prior to the timing at which the overflow drain signal φOFD rises is defined as a long exposure time period, and the period after the timing at which the overflow drain signal φOFD rises is defined as a short exposure time period. The overflow drain voltage can also be changed between the long exposure time period and the short exposure time period. As a result, more signal charges can be accumulated. Note that the overflow drain voltage is usually fixed.

As described above, low intensity X-rays are irradiated either once or twice with different lengths of irradiation time periods, and the X-rays are exposed at the photodiodes PD corresponding to each irradiation, or exposed with the shutter timing, to output imaging signals, thereby obtaining an image with a wide dynamic range. For a site of a living body at which X-rays are readily absorbed, an image with clear light and shade cannot be obtained without long time irradiation of X-rays. Further, for a site of a living body at which X-rays are not absorbed, an image with clear light and shade can be obtained with short time irradiation of X-rays. Long time irradiation of X-rays onto a site of a living body at which X-rays are not absorbed results in a black and flattened image. Thus, synthesization of a light portion by short time irradiation of X-rays with a dark portion by long time irradiation of X-rays enables an image to be obtained in which both the light portion and the dark portion are clear. The imaging in this case can have either a still image or a video image applied to the subject.

Therefore, according to the present embodiment, the reading of imaging signals from the CCD image sensors 1 to 12 are performed by the CCD controller 22 twice, once during the long exposure time period and once during the short exposure time period with respect to the irradiation of a constant dose of radiation by the X-ray generator 25; and the main controller 26 allows the memory 24 to synthesize the image data from the successively twice-read imaging signals into an image with proper timing. As a result, a wider dynamic range can be obtained with a radiation dose weak enough not to cause a harmful influence to a subject, such as a human body and other substances, it becomes unnecessary to irradiate strong radiation onto such a subject as is done conventionally, and it becomes possible to obtain a response with a wider dynamic range.

According to the present embodiment, the long time irradiation of the X-rays and the reading thereof are performed first; however, without the limitation stipulated above, the short time irradiation of the X-rays and the reading thereof may be performed prior to the long time irradiation of the X-rays and the reading thereof.

Further, according to the present embodiment, the frame accumulation driving has been described in which signal reading from the photodiodes PD (pixels) is performed by dividing lines into odd-number lines and even-number lines; however, in addition to this or separate from this, signal reading from the photodiodes PD (pixels) maybe carried out by field accumulation driving in which signal reading from the photodiodes PD (pixels) is performed by adding pixel data of the odd-number lines and even-number lines together.

In addition, during the multiple readings, it is also possible to perform an exposure containing useful information by the frame accumulation driving and to perform the other exposures by the field accumulation driving.

By this driving method, it becomes possible to increase the signal reading rate, and therefore, signal reading can be performed in seventy-five percent of the time.

In addition, the combination of the long time exposure and the short time exposure during the driving of the CCD solid-state imaging elements allows a high dynamic range to be obtained; however, without the limitation stipulated above, such a high dynamic range can also be obtained with a combination of a long time exposure, a middle time exposure and a short time exposure by performing the reading three times. Such a high dynamic range can also be obtained by performing multiple exposure time periods and multiple signal readings.

Examples of a site to be imaged during the long time exposure and a site to be imaged during a middle or short time exposure will be described hereinafter.

Even the same site maybe an imaging area, for example, the lung is to be imaged during the long time exposure while a bone or the like is to be imaged during the middle or short time exposure.

In chest photographing, there is a difference in the

X-ray absorptivity between a bone part and a lung part. Due to the difference in X-ray absorptivity, the light amount to the CCD solid-state imaging elements varies. In addition, X-rays pass through a living body, such as a human body, resulting in halation. An attempt to image a part with low absorptivity or a part with high absorptivity with high definition using the current solid-state imaging elements will not succeed in obtaining a fine image due to the narrow dynamic range. However, an image obtained by the long time exposure for a part with high absorptivity and an image obtained by the middle or low time exposure for a part with low absorptivity can be overlapped and synthesized with each other as one image, so that a clearer image with a high dynamic range can be obtained. In this case, a correction method is also important in the image synthesizing.

Further, the definition of the time with regard to the long time exposure as well as the middle and short time exposures will be described hereinafter.

For example, the long time exposure can be set to ten seconds while the middle and short time exposure can be set to one second.

Although the exposure varies depending on a site to be measured, it is defined to be from 50 msec to 500 msec for the long time exposure, and it is defined to be up to 50 msec for the middle and short time exposures. The time period for the short time exposure is set to be one-tenth or less of that of the long time exposure. The time setting of one second or more will result in a blur of a body in motion, which is not realistic.

According to the present embodiment, the CCD image sensor functioning as an imaging section is divided into a plurality of divided areas (twelve CCD image sensors 1 to 12, hereinafter), and each of the plurality of divided areas includes: a plurality of photodiodes PD arranged two dimensionally for performing a photoelectric conversion; an electric charge transferring section for reading and transferring signal charges in a predetermined direction, which are photoelectrically converted by the photodiode PD; and an output section for converting the signal charges transferred by the electric charge transferring section into voltages, and amplifying the converted voltages to allow imaging signals to be output. Without the limitation stipulated above, it is also possible to configure the present invention even when the imaging section is one area instead of being divided into a plurality of divided areas, and the imaging section includes: a plurality of photodiodes PD arranged two dimensionally for performing a photoelectric conversion; an electric charge transferring section for reading and transferring signal charges in a predetermined direction, which are photoelectrically converted by the photodiode PD; and an output section for converting the signal charges transferred by the electric charge transferring section into voltages, and amplifying the converted voltages to allow imaging signals to be output. Further, according to the present embodiment, the CCD image sensor has been described as an imaging section; however, without the limitation stipulated above, a CMOS image sensor (CMOS solid-state imaging element) may be used as the imaging section.

The CMOS image sensor functioning as an imaging section includes a photodiode PD, as a photoelectric conversion section, formed as a front surface layer of a semiconductor substrate of the CMOS image sensor. Adjacent to the photodiode PD, an electric charge transferring section of an electric charge transferring transistor (electric charge transfer means) is provided for transferring signal charges to a floating diffusion section FD. Agate electrode is provided, as an extraction electrode, above the electric charge transferring section with a gate insulation film interposed therebetween. Further, the CMOS image sensor includes a reading circuit, in which signal charges transferred to the floating diffusion section FD for each photodiode PD are converted into voltages and amplified in accordance with the converted voltages, and the reading circuit reads an amplified signal as an imaging signal for each pixel section. In summary, similarly to the CCD image sensor described above, the CMOS image sensor may be divided into a plurality of divided areas (e.g., twelve CMOS image sensors), and each of the divided areas may include: a plurality of photodiodes PD arranged in two dimensions for performing a photoelectric conversion; an electric charge transferring section for transferring signal charges to a floating diffusion section FD in a predetermined direction, which are photoelectrically converted by the photodiode PD; and a signal reading circuit, in which signal charges transferred to the floating diffusion section FD are converted into voltages and amplified in accordance with the converted voltages, and the signal reading circuit reads an applied signal as imaging signals for each pixel section.

Similarly to the case of the CCD image sensor, in the case of the CMOS image sensor, the imaging section includes: a plurality of photodiodes PD arranged two dimensionally for performing a photoelectric conversion; an electric charge transferring section for reading and transferring signal charges in a predetermined direction (to a floating diffusion section FD in the case of the CMOS image sensor), which are photoelectrically converted by the photodiode PD; and an output section (a signal reading circuit in the case of the CMOS image sensor) for converting the signal charges transferred by the electric charge transferring section into voltages, and amplifying the converted voltages to allow imaging signals to be output.

As described above, the present invention is exemplified by the use of its preferred embodiment. However, the present invention should not be interpreted solely based on the embodiment described above. It is understood that the scope of the present invention should be interpreted solely based on the claims. It is also understood that those skilled in the art can implement equivalent scope of technology, based on the description of the present invention and common knowledge from the description of the detailed preferred embodiment of the present invention. Furthermore, it is understood that any patent, any patent application and any references cited in the present specification should be incorporated by reference in the present specification in the same manner as the contents are specifically described therein.

### INDUSTRIAL APPLICABILITY

The present invention can be applied in the field of a radiographic imaging system, such as an X-ray imaging system, used, for example, for X-ray mammography and photographing of the chest and the appendicular skeleton. According to the present invention, the reading of imaging signals from the imaging section is performed multiple times at different exposure time periods with respect to the irradiation of a constant dose of radiation by a radiation generating section, and image data, which is obtained from imaging signals readout multiple times, is synthesized for an image. Therefore, a response with a wider dynamic range can be obtained, without a need for irradiating strong radiation onto a subject (a human body), as is done conventionally.

1. A radiographic imaging system, comprising:
a radiation generating section for generating and irradiating radiation onto a subject;
a scintillator section for converting the radiation from the subject into light;
an imaging section for performing a photoelectric conversion on the light from the scintillator section and imaging the light as an image of the subject; and
a controlling section for reading imaging signals from the imaging section multiple times with a different length of an exposure time period with respect to the irradiation of a constant dose of radiation by the radiation generating section, and controlling to synthesize image data from the imaging signals read out multiple times into an image.

2. A radiographic imaging system according to claim 1, wherein in the imaging section, at least two exposures of at least one of a long time exposure and at least one of a short time exposure are performed under the control of the controlling section, and readings by the imaging section are performed at least twice corresponding to at least once with the long time exposure and at least once with the short time exposure.

3. A radiographic imaging system according to claim 2, wherein the long time exposure is from 50 msec to 500 msec, and the short time exposure is one-tenth or less of the long time exposure.

4. A radiographic imaging system according to claim 1, further including an A/D conversion section for performing A/D conversion on the imaging signals read from the imaging section, and a storage section for temporarily storing graphic signals from the A/D conversion section.

5. A radiographic imaging system according to claim 4, wherein the storage section synthesizes at least the graphic signals from the long time exposure and the graphic signals from the short time exposure of the imaging section.

6. A radiographic imaging system according to claim 1, wherein the radiation generating section irradiates radiation with a radiation dose weak enough not to cause a harmful influence to the subject.

7. A radiographic imaging system according to claim 6, wherein the radiation dose ranges 170 μGy (microgray) ±20 μGy (microgray).

8. A radiographic imaging system according to claim 1, wherein the imaging section includes: a plurality of photodiodes arranged in two dimensions for performing a photoelectric conversion; an electric charge transferring section for reading and transferring signal charges in a predetermined direction, which are photoelectrically converted by the photodiode; and an output section for converting the signal charges transferred by the electric charge transferring section into voltages, and amplifying the converted voltages to allow imaging signals to be output.

9. A radiographic imaging system according to claim 1, wherein the imaging section are divided into a plurality of divided areas, each of the plurality of divided areas including:
a plurality of photodiodes arranged in two dimensions for performing a photoelectric conversion;
an electric charge transferring section for reading and transferring signal charges in a predetermined direction, which are photoelectrically converted by the photodiode; and
an output section for converting the signal charges transferred by the electric charge transferring section into voltages, and amplifying the converted voltages to allow imaging signals to be output.

10. A radiographic imaging system according to claim 1, wherein the controlling section controls at least signal output of the imaging signals from the long time exposure and the imaging signals from the short time exposure of the imaging section.

11. A radiographic imaging system according to claim 1, wherein during a state of irradiating radiation by the radiation generating section, an electric potential of the imaging section is reset with the timing of an electronic shutter, by the timing at which an overflow drain signal rises; and a period prior to the timing at which the overflow drain signal rises is defined as one of a long exposure time period or a short exposure time period, while a period after the timing at which the overflow drain signal rises is defined as the other one of the long exposure time period or the short exposure time period.

12. A radiographic imaging system according to claim 11, wherein an overflow drain voltage is either the same or changed during the long exposure time period and the short exposure time period.

13. A radiographic imaging system according to claim 1, wherein the imaging section is constituted of a solid-state imaging array, which is two dimensionally arranged facing the scintillator section.

14. A radiographic imaging system according to claim 1, wherein the scintillator section includes an image intensifier provided therein as an amplifier.

15. A radiographic imaging system according to claim 1, wherein the radiation is any of X-rays, an electron beam, ultraviolet rays and infrared rays.

16. A radiographic imaging system according to claim 9, wherein the radiographic imaging system uses at least one of a frame accumulation driving in which signal reading from the photodiode is performed by dividing lines into odd-number lines and even-number lines, or a field accumulation driving in which signal reading from the photodiode is performed by adding data from odd-number lines and even-number lines.

17. A radiographic imaging system according to claim 16, wherein during the multiple readings, an exposure containing useful information is performed by the frame accumulation driving and the other exposures are performed by the field accumulation driving.
